(19) United States
(12) Patent Application Publication
(10) Pub. No.: US 2017/0130726 A1
(43) Pub. Date: May 11, 2017

(54) DESKTOP LAMP WITH A BLADELESS FAN

(71) Applicant: SHANGYU SUNSHINE ELECTRONIC CO., LTD., Shaoxing City (CN)

(72) Inventor: Guangcan Qin, Shaoxing (CN)

(21) Appl. No.: 14/936,647

(22) Filed: Nov. 9, 2015

(51) Int. Cl. F04D 25/08; F04D 25/06; F21V 1/00; F21V 23/00; F21S 6/00; F21V 33/00

(52) U.S. Cl. CPC F04D 25/08; F21S 6/002; F21V 33/0096; F21V 1/00; F21V 23/008; F04D 25/06; F21Y 2101/02

(57) ABSTRACT

A desktop lamp with an bladeless fan comprises a base, a wind arm and a lamp assembly. The base includes an upper inner space, a lower inner space and a rear opening. The upper inner space is formed inside the base. The lower inner space is formed underneath the upper inner space and is configured for holding a blower. The rear opening is formed on a rear surface of the base. The blower communicates with the upper inner space, and the rear opening communicates with the blower, which allows the blower to produce airflows from the rear opening toward the upper inner space. The wind arm is mounted on the base and includes a wind tunnel and a wind outlet, which longitudinally blows the airflows out from the air arm. The lamp assembly is mounted on the wind arm, and is used for illuminations.

### FIELD OF THE INVENTION

Embodiments of the present invention relate to desktop lamps, especially toward a desktop lamp with a bladeless fan that is able to produce wind and illumination simultaneously.

### BACKGROUND

Desktop lamps have been widely used for desks to provide illumination of reading. The illumination of the desktop lamp must provide sufficient light and suitable lighting angle of users which protects users' eyes.

Further, some tiny gadgets like the mini USB fan that is able for a user that plug its wire into the USB jacket of a personal computer (PC) or a notebook (NB), which is very suitable for personal use. It normally stands on the desk to provide a smooth wind blow to the user and makes the user more comfortable especially for the hot weather.

Therefore, there is a need for an approach to provide a device or means to allow an electronic device to be able to provide an integrated functions of a lamp and a fan, and remain the high quality of illumination.

### SOME EXEMPLARY EMBODIMENTS

These and other needs are addressed by the present invention, wherein an approach is to provide a desktop lamp with a bladeless fan, which is able to produce wind and illumination simultaneously.

According an embodiment of the present invention, a desktop lamp with a bladeless fan comprises a base, a wind arm and a lamp assembly. The base includes an upper inner space, a lower inner space and a rear opening. The upper inner space is formed inside the base. The lower inner space is formed underneath the upper inner space and is configured for holding a blower. The rear opening is formed on a rear surface of the base. The blower communicates with the upper inner space, and the rear opening communicates with the blower, which allows the blower to produce airflows from the rear opening toward the upper inner space. The wind arm is mounted on the base and includes a wind tunnel and a wind outlet, which longitudinally blows the airflows out from the air arm. The lamp assembly is mounted on the wind arm, and is used for illuminations.

Accordingly, the present disclosure is able to provide a fan function with constant airflows yet that still allows for proper operation of the illuminations of the desktop lamp.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is an exemplary diagram of a front view of a desktop lamp with a bladeless fan in accordance with an embodiment of the present invention; and

FIG. 2 is an exemplary diagram of a cross sectional view of partial FIG. 1.

### DESCRIPTION OF THE PREFERRED EMBODIMENT

A desktop lamp with a bladeless fan is disclosed. In the following description, for the purposes of explanation, numerous specific details are set forth in order to provide a thorough understanding of the present invention. It is apparent, however, to one skilled in the art that the invention may be practiced without specific details or with an equivalent arrangement.

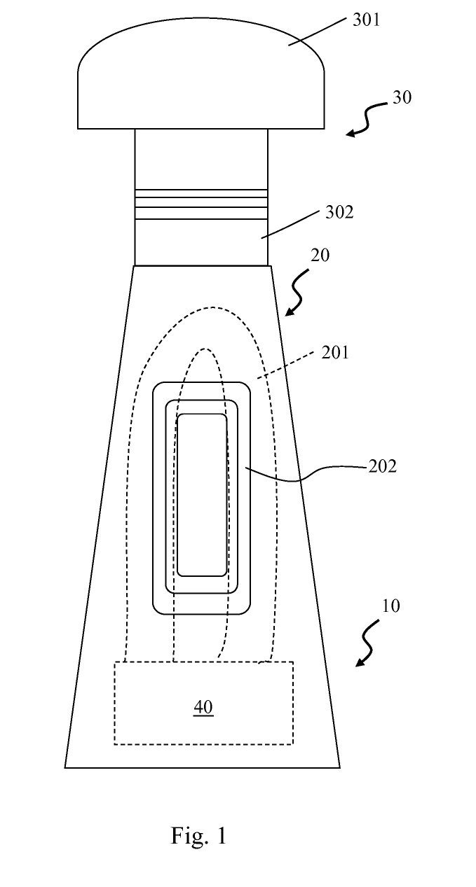

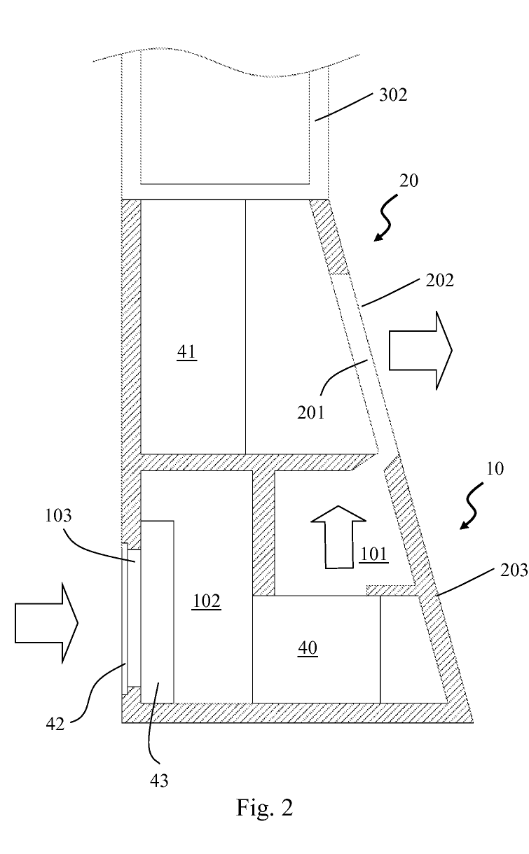

With reference to FIGS. 1 and 2, FIG. 1 is an exemplary diagram of a front view of a desktop lamp with a bladeless fan in accordance with an embodiment of the present invention; and FIG. 2 is an exemplary diagram of a cross sectional view of partial FIG. 1.

In this embodiment, the desktop lamp with a bladeless fan comprises a base 10, a wind arm 20 and a lamp assembly 30. The base 10 is configured for placing the desktop lamp on the desk and includes an upper inner space 101, a lower inner space 102 and a rear opening 103. The upper inner space 101 is formed inside the base 10. The lower inner space 102 is formed underneath the upper inner space, and is used for containing a blower 40. The rear opening 103 is formed on a rear surface 104 of the base 10. The electrical module 41 obtain electrical power from an external power source and powers the blower 40. The blower 40 may be a micro Direct Current (DC) blower, brushless fan or any other micro fan that is adequate for the desktop electronic applications.

As shown in FIG. 2, The blower 40 is installed inside the lower inner space 102, and is place between the upper inner space 101 and the rear opening 103. The blower 40 communicates with the upper inner space 101 on one side, and communicates with the rear opening 103 on another side. The blower 40 produces airflows 41 from the rear opening 103 toward the upper inner space 101, which sucks air externally from the rear side of the base 10. The desktop lamp with a bladeless fan may further comprises an electrical module 41 located inside the upper inner space 101, the lower inner space 102 or the wind arm 20. As shown in FIG. 2 of one embodiment, the electrical module 41 is located inside the wind arm 20.

The desktop lamp with a bladeless fan further have a cover 42 and a filter mesh 43 placed on the rear opening 103. The filter mesh 43 may be an anti-germ carbon filter mesh that is located between the cover 42 and the lower inner space 102. When the blower 40 is operating whereby sucking external air from the rear opening 103 of the base 10, the filter mesh 43 blocks dusts that is able to provide functionality of air cleaning.

The wind arm 20 is vertically mounted on the top of the base 10, and has a wind tunnel 201 formed inside the wind arm 20, and a wind outlet 202. The wind tunnel 201 communicates with the upper inner space 101 of the base 10. The wind outlet 202 forms on a front surface of the wind arm 20, which communicates with the corresponded wind tunnel 201.

In one embodiment, as shown in FIG. 1, the wind tunnel 201 is formed in a ring shape which has two diverged paths extended from the upper inner space 101 inside the wind arm 20. The wind outlet 202 is also formed in a ring shape corresponding to the wind tunnel 201.

It is noted that the sectional diameters of the wind tunnel 201 is smaller than the upper inner space 101, and the opening size of the wind tunnel 201 is much smaller than the sectional diameter of the wind tunnel 201. Because of the pressure differences, it guides the accumulated air of the upper inner space 101 fully into the wind tunnel 201 and blows the airflows longitudinally out from the wind arm 20 smoothly.

However, it is also noted that the present invention is different than other fanless blower such as Dyson®. Dyson® uses special assemblies that enhances the air pressure for a crack all around the ring to have more constant and high speed airflow wind than traditional fan. The present invention does not increase pressure of airflows. The airflow is guided inside the wind tunnel 201, the airway resistance will slow down the speed of the airflow, which is more suitable for desktop use.

The lamp assembly 30 is mounted on the wind arm 20, is configured for illuminations, and has a lampshade 301 and a lamp arm 302. The lampshade 301 has a light source (e.g., LED light source) installed inside the lampshade 301. The light source is driven and/or controlled by the electrical module 41. The light source may be a light bulb, a CCFL or an LED tube. The lamp arm 302 is placed between the lampshade 301 and the wind arm 20, which is configured for adjusting illuminating angle of the light source. The lamp arm 302 may be a flexible soft tube or any other mechanism that is able of change the illuminating angle.

The light source and blower 40 are driven, powered and/or controlled by the electrical module 41. A front surface 203 of the base may further have a control panel (not shown) that connects to the electrical module 41, which allows the user to adjust the illuminations and speed of the blower 40. A person skilled in the art will realize how to drive the light source and blower 40, and thus not described in detail herein.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A desktop lamp with a bladeless fan, comprising:
a base having:
an upper inner space;
a lower inner space, underneath the upper inner space, being configured for installing a blower, wherein the blower communicates with the upper inner space, and is driven by an electrical module; and
a rear opening being formed on a rear surface of the base, which communicates with the blower that allows the blower producing airflows from the rear opening toward the upper inner space;
a wind arm being mounted on the base and having:
a wind tunnel being formed inside the wind arm and communicating with the upper inner space of the base; and
a wind outlet being formed on a front surface of the wind arm, which longitudinally blows the airflows out; and
a lamp assembly being mounted on the wind arm, and being powered by the electrical module for illuminations.

2. The desktop lamp with a bladeless fan as claimed in claim 1, wherein the blower is a micro Direct Current (DC) blower or a brushless fan.

3. The desktop lamp with a bladeless fan as claimed in claim 1, further comprising a cover and a filter mesh.

4. The desktop lamp with a bladeless fan as claimed in claim 1, wherein the wind tunnel is formed in a ring shape which has two diverged paths extended from the upper inner space inside the wind arm.

5. The desktop lamp with a bladeless fan as claimed in claim 4, wherein the wind outlet is formed in a ring shape corresponding to the shape of the wind tunnel.

6. The desktop lamp with a bladeless fan as claimed in claim 1, wherein the lamp assembly comprises
a lampshade having a light source installed inside the lampshade, and the light source is driven by the electrical module; and
a lamp arm being placed between the lampshade and the wind arm.

7. The desktop lamp with a bladeless fan as claimed in claim 1, wherein a front surface of the base has a control panel that connects to the electrical module.

8. The desktop lamp with a bladeless fan as claimed in claim 1, wherein the electrical module is located inside the upper inner space, the lower inner space or the wind arm.
